(19) United States
(12) Patent Application Publication
(10) Pub. No.: US 2018/0104520 A1
(43) Pub. Date: Apr. 19, 2018

(54) SOIL-BASED FIRE SUPPRESSION SYSTEM

(71) Applicant: GARY BRIAN SNODGRASS, LAS VEGAS, NV (US)

(72) Inventor: GARY BRIAN SNODGRASS, LAS VEGAS, NV (US)

(21) Appl. No.: 15/293,596

(22) Filed: Oct. 14, 2016

(51) Int. Cl. A62C 31/02; A62C 3/02; A62C 31/28; B05B 7/14

(52) U.S. Cl. CPC A62C 31/02; A62C 3/0292; A62C 99/0045; B05B 7/144; B05B 7/1486; A62C 31/28

(57) ABSTRACT

Implementations are disclosed herein that relate to a firefighting system. An example provides a firefighting system comprising a conveyance configured to receive and elevate screened soil, a chute configured to receive the screened soil at an entry point, and a nozzle configured to emit the screened soil toward a fire site, the nozzle comprising an augmentation device configured to increase a flow speed of the screened soil.

### FIELD OF THE INVENTION

The present invention relates generally to fire suppression, and more particularly to a system for suppressing fires using soil.

### BACKGROUND OF THE INVENTION

Fires are a common phenomenon in the environment, and arise from natural causes such as lightning, or human actions that are negligent or deliberate (e.g., arson). Many fires pose great danger with respect to human life, property damage, and environmental damage, and often spread if left unattended. For these and other reasons, fires often necessitate human intervention to achieve their suppression or extinguishing.

A variety of approaches to fire suppression have been developed. Many approaches involve deploying a plurality of trained firefighters, specialized equipment (e.g., fire trucks, helicopters and/or other aircraft), and extinguishing chemicals and/or water. As such, the monetary and logistical cost of firefighting can be staggering. These and other issues may be exacerbated by the scarcity of firefighting resources and/or the increasing prevalence of environmental conditions (e.g., drought, climate change) that are conducive to fire. Characteristics of a site at which a fire burns may complicate fire suppression as well, such as its remote location (e.g., in the wilderness), low accessibility (e.g., high elevation, rough terrain), etc.

Even when successfully deployed to a burn site, a firefighting brigade may face factors which reduce its efficacy. For example, a tradeoff may be imposed between the ability to closely approach a fire yet maintain a sufficient distance to protect firefighters and equipment.

Several attempts have been made to resolve the above problems by using soil as a fire suppressant. However, these attempts have various limitations and problems. For example, the attempts require vehicles to be placed in dangerous proximity to a fire, require expensive and imported sand for operation, or are not able to project soil effectively.

As such, there exists a need for a firefighting system that can reduce the cost, complexity, challenges, and risks associated with traditional firefighting approaches.

### SUMMARY OF THE INVENTION

This summary is provided to introduce a selection of concepts in a simplified form that are further described below in the detailed description. This summary is not intended to identify key features of essential features of the claimed subject matter, nor is it intended to be used to limit the scope of the claimed subject matter. Furthermore, the claimed subject matter is not limited to implementations that solve any or all disadvantages noted in any part of this disclosure.

Disclosed is a firefighting system, the firefighting system comprising, a conveyance configured to receive and elevate screened soil, a chute configured to receive the screened soil at an entry point, and a nozzle configured to emit the screened soil toward a fire site, the nozzle comprising an augmentation device configured to increase a flow speed of the screened soil.

In another aspect, the augmentation device comprises an auger.

In another aspect, the augmentation device comprises a rotary projector.

In another aspect, the augmentation device comprises a gas augmentation system that selectively introduces a pressurized gas into the nozzle.

In another aspect, the gas augmentation system comprises a tank holding the pressurized gas.

In another aspect, the gas augmentation system further comprises a control system configured to selectively control the introduction of the pressurized gas into the nozzle.

In another aspect, the firefighting system is at least collapsible.

In another aspect, the chute is configured to increase a speed of the screened soil by reducing an elevation of the screened soil via gravity.

In another aspect, the soil is emitted at an exit point after passing the auger or other augmentation device.

In another aspect, a differential height between the entry point and the exit point is between 20 and 50 ft.

In another aspect, the conveyance comprises a conveyer belt.

In another aspect, a distance between the nozzle and the fire site is between 50 and 150 ft.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the claimed subject matter will hereinafter be described in conjunction with the appended drawings provided to illustrate and not to limit the scope of the claimed subject matter, where like designations denote like elements, and in which:

FIG. 1 presents an exemplary firefighting system, in accordance with aspects of the present disclosure;

FIG. 2 schematically presents an exemplary soil screening process, in accordance with aspects of the present disclosure;

FIG. 3 presents an example of supplying screened soil to the exemplary firefighting system of FIG. 1, in accordance with aspects of the present disclosure;

FIG. 4 presents an example of supplying screened soil from a reservoir to a conveyance of the firefighting system of FIG. 1, in accordance with aspects of the present disclosure;

FIG. 5 presents a cross-sectional view of an exemplary implementation of an augmentation system, where the cross section is taken along a longitudinal axis of a nozzle to show internal components of the augmentation system, in accordance with aspects of the present disclosure;

FIG. 6 presents a cross-sectional view of another exemplary implementation of the augmentation system, where the cross section is taken along a longitudinal axis of a nozzle to show internal components of the another augmentation system, in accordance with aspects of the present disclosure;

FIG. 7 presents a partial view of the exemplary firefighting system of FIG. 1 emitting screened soil toward a fire site, in accordance with aspects of the present disclosure;

FIG. 8 schematically presents an exemplary fire suppression method, in accordance with aspects of the present disclosure; and

FIG. 9 presents an example of a continuous conveyance system, in accordance with aspects of the present disclosure.

It is to be understood that like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Disclosed is a firefighting system. An example provides a firefighting system comprising a conveyance configured to receive and elevate screened soil, a chute configured to receive the screened soil at an entry point, and a nozzle configured to emit the screened soil toward a fire site, the nozzle comprising an augmentation device configured to increase a flow speed of the screened soil.

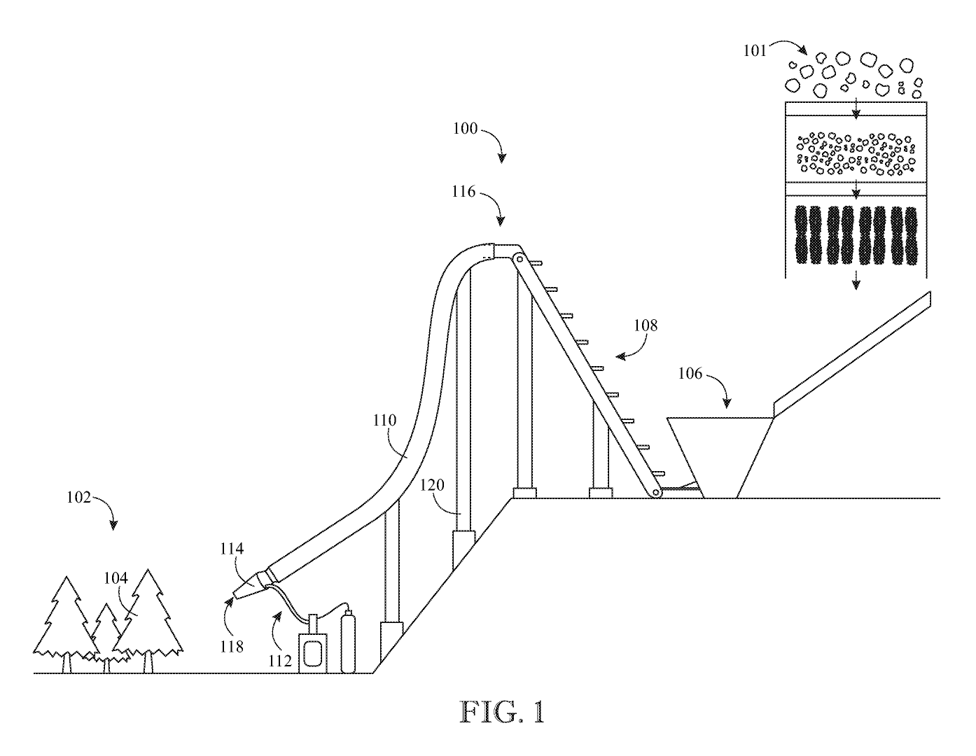

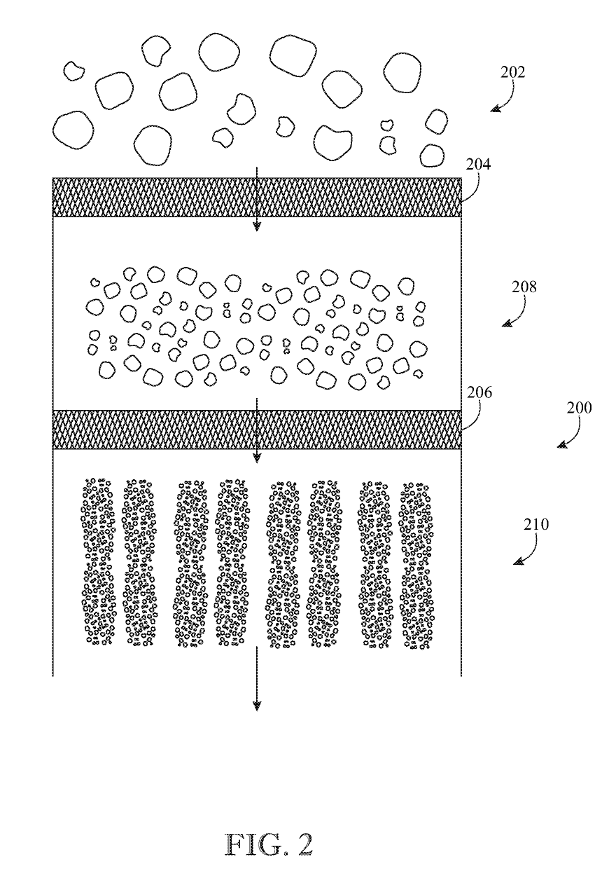

The illustration of FIG. 1 presents an exemplary firefighting system 100. As schematically indicated at 101, firefighting system 100 is configured to receive screened soil that may be propelled at relatively high speeds and accurately aimed toward a fire site 102 (e.g., trees 104) in order to suppress and/or extinguish the fire. As used herein, “soil” may generally refer to a collection of commingled environmental debris or material available at a site where firefighting system 100 is deployed, and may include a variety of elements (e.g., minerals, organic matter) that can be collectively referred to as dirt or soil. It is to be understood that if there is too much organic matter at the site, another location for collecting and processing soil may be selected (e.g. a proximate location having less organic matter). By enabling the use of soil at a deployment site for fire suppression, firefighting system 100 may reduce or eliminate costs and infrastructural requirements associated with fire suppression agents (e.g., water and other chemical compounds) and their collection, storage, and transportation. It will be understood, however, that fire suppression agents other than soil may be used by firefighting system 100 in combination with soil. Further, soil fed to firefighting system 100 may be collected at or proximate to fire site 102 and/or other locations not proximate to the fire site. Details regarding the collection and processing of soil are described below with reference to the illustration of FIG. 2.

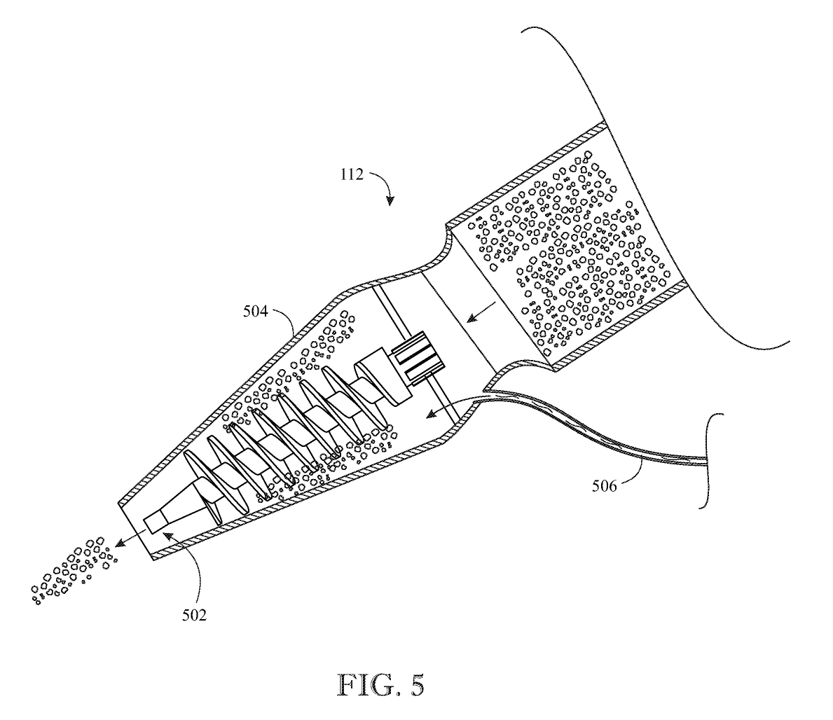

Screened soil may be fed to a reservoir 106 which in turn feeds the screened soil to a conveyance 108. Conveyance 108 is configured to lift the screened soil to a desired elevation, thereby imbuing the screened soil with gravitational potential energy which can be converted to kinetic energy to raise the speed and momentum of the screened soil. Firefighting system 100 may thus be referred to as a “gravity-assisted” system. In this way, a concentrated and potentially pressurized and/or high speed stream of screened soil can be supplied to fire site 102 for suppressing fire therein. Once raised to the desired elevation by conveyance 108, the screened soil may be fed to a chute 110 in which the screened soil can travel toward a relatively lower elevation while gaining speed and momentum via gravity. An augmentation system, generally indicated at 112, may complement the assistance provided by gravity by further increasing the speed and momentum of the screened soil stream. Details regarding various implementations of augmentation system 112 are described below with reference to the illustrations of FIGS. 5-7.

Following its interaction with augmentation system 112, the screened soil stream may pass through a nozzle 114, which may provide—e.g., via tapering geometry—a concentrated orifice through which the soil stream can be emitted with high accuracy, thereby reducing wasted soil. The configuration of nozzle 114 may further reduce turbulence and/or clouding of the soil stream.

As an example, chute 110 may have a diameter between 6 in and 2 ft, a length (e.g., unfurled length) between 50 and 150 ft or between 25 and 200 ft, and may be comprised of steel or other fire-resistant materials. As another example, the differential height between an entry point 116 at which screened soil enters chute 110, and an exit point 118 at which the screened soil exits nozzle 114, may be between 20 and 50 ft or between 10 and 100 ft. As yet another example, the distance between exit point 118 where the screened soil exits nozzle 114, and the point at which the emitted soil contacts locations at fire site 102 (e.g., trees 104), may be between 50 and 150 ft or between 25 and 200 ft. In this way, the screened soil may be emitted in a manner that accurately targets fires within fire site 102 yet is emitted from a distance away from the fire site that sufficiently separates human operators and firefighting system 100 from the fire site—e.g., sufficient separation may be achieved from the high temperatures at the fire site, in particular. Any suitable dimensions, emission ranges, and material compositions are possible, however.

Firefighting system 100 may be collapsible to enable rapid, dynamic, and reversible deployment. The illustration of FIG, 1 presents a plurality of supports such as support 120 that are configured to stably support and suspend (e.g., vertically) portions of firefighting system 100 such as chute 110 and/or conveyance 108. Supports 120 may be collapsible via any suitable mechanism, including but not limited to being comprised of multiple sections that may be removably affixed to one another, and/or having a telescoping configuration that is axially collapsable. As another example, chute 110 may be configured with a concertina-type hinge mechanism to facilitate axial collapsing. As yet another example, conveyance 108 may be slidingly collapsible, for example via a sliding or telescoping mechanism. In this way, firefighting system 100 may be rapidly deployable at a variety of fire sites having varying geographic properties (e.g., mountains, range areas) while supporting its removal from such fire sites and reuse across different fire sites.

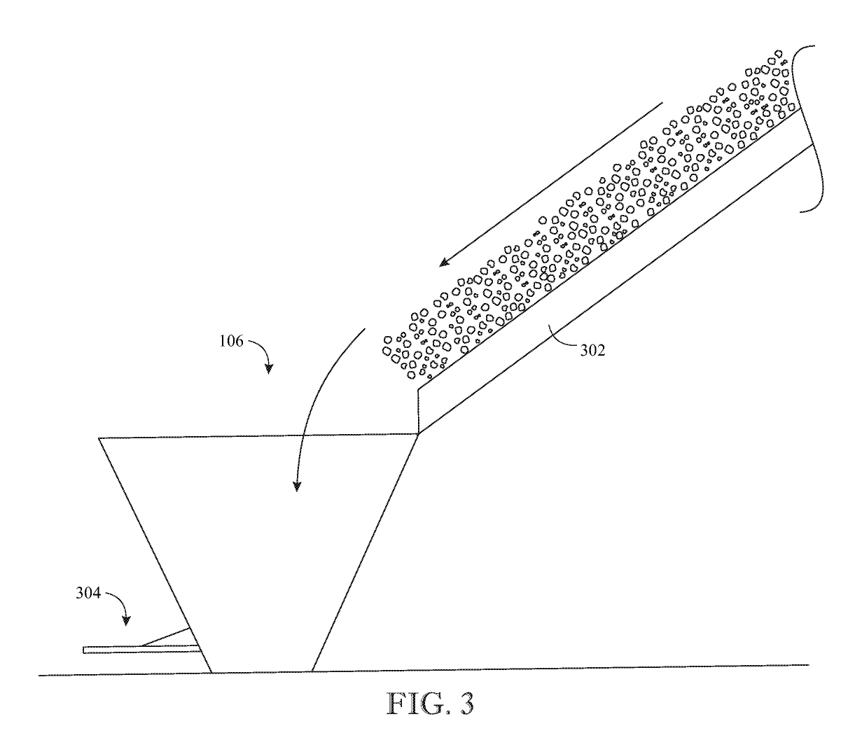

The illustration of FIG. 2 schematically presents an exemplary soil screening process 200. Process 200 may be employed to produce screened, processed soil that can be fed to firefighting system 100 for its application to fire site 102. At 202, unscreened soil is supplied to a coarse soil screen 204. The unscreened soil may be unprocessed soil collected from fire site 102 or a location proximate to the fire site, for example, and may be collected via any suitable mechanism including but not limited to collection via heavy equipment such as a backhoe, earth mover, etc. Coarse screen 204 may substantially filter out soil particles above a threshold size to produce coarsely-screened soil, which is then supplied to a fine soil screen 206 at 208. Fine soil screen 206 filters the coarsely-screened soil to produce finely-screened soil at 210. The finely-screened soil may then be supplied to firefighting system 100 as described in further detail below with reference to the illustration of FIG. 3. It will be understood, however, that process 200 is provided as an example and various modifications are contemplated, such as modifying the number and type of screens employed in the process.

The finely-screened soil may substantially include and exclude particles of various size ranges. As one example, the finely-screened soil may substantially include particles less than 2.0 mm (e.g., average diameter). As another example, the finely-screened soil may substantially include particles up to 0.02 mm (e.g., fine soil, silt) and/or up to 0.10 mm moderately sized sand), and/or up to 1.0 mm (e.g., large sand and soil particles). It will be understood that the size of finely-screened soil produced via process 200 may vary with various environmental conditions such as moisture, clay content density, and/or mineral content. Further, while not depicted in the illustration of FIG. 2, process 200 may employ alternative or additional components such as grinders, atomizers, vibrators, vacuums, etc., and/or may include pathways for separately routing particles of different size ranges—e.g., to eject excessively large particles to a location outside of the area in which soil is collected for screening via the process. For example, one or more of the screens shown in FIG. 2 may be vibrated or shaken such that the soil properly filters through the screens, and such that blockage at the screens is reduced.

Process 200 may enable continuous production of screened soil that can be sufficiently used by firefighting system 100 to suppress fire without degrading the firefighting system in an interrupted manner. The uninterrupted provision of screened soil may be advantageous, as the interruption of fire suppression can severely inhibit firefighting—e.g., interruption caused by excessively large debris or particles that might otherwise be fed to firefighting system 100. Instead, process 200 enables the provision of so-called “pre-screened” or “pre-sized” soil to firefighting system 100 with undesirable particles, rocks, debris, and the like removed.

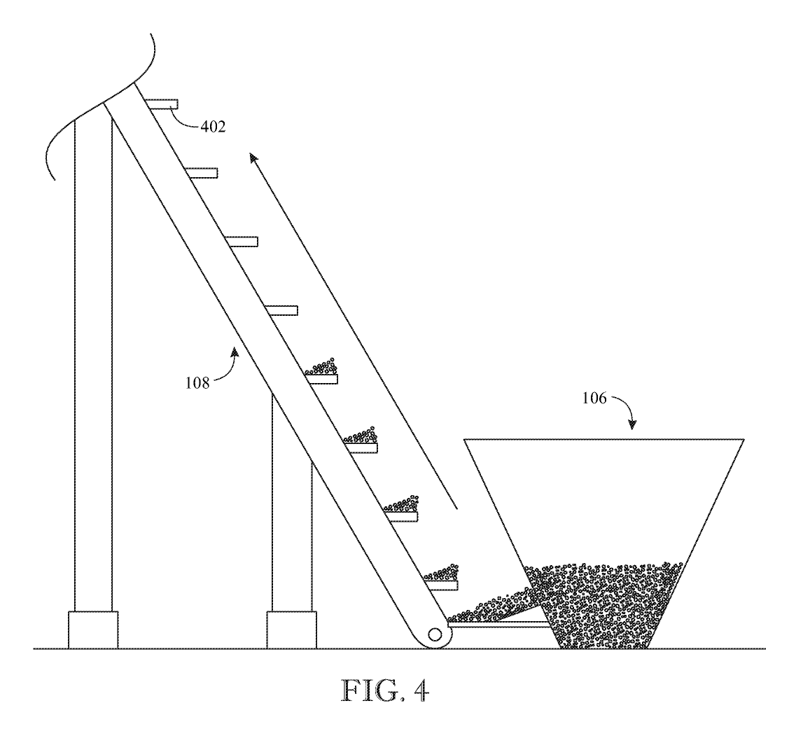

The illustration of FIG. 3 presents an example of supplying screened soil to firefighting system 100 of the illustration of FIG. 1. Process 200 of the illustration of FIG. 2 may be used to produce the screened soil, for example. The screened soil is conveyed downwardly via a slide 302 into reservoir 106, which may be a hopper, for example. Reservoir 106 may exhibit a tapered shape and includes a collapsible door 304 through which screened soil collected in the reservoir can be supplied to conveyance 108 as further shown in the illustration of FIG. 4. Reservoir 106 may be endowed with any suitable mechanism to enable the supply of screened soil to conveyance 108, however.

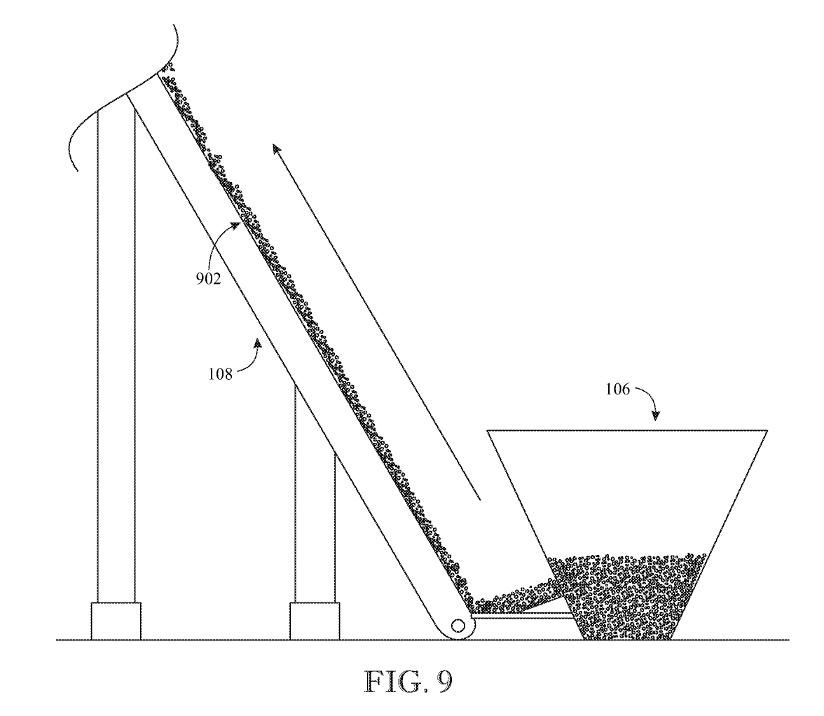

The illustration of FIG. 4 presents an example of supplying screened soil from reservoir 106 to conveyance 108. As shown therein, conveyance 108 may assume the form of a conveyor belt, but other suitable forms are contemplated. Conveyance 108 may include a plurality of steps such as step 402 that are each operable to receive a portion (e.g., metered portion) of screened soil from reservoir 106 (e.g., via door 304) and raise the portion for supply to entry point 116 of chute 110 as shown in the illustration of FIG. 1. As yet another example in addition to those described above, conveyance may lift screened soil up to 250 ft (e.g., from the height at which it is received from reservoir 106). It is to be understood that conveyance 108 may omit the steps 402 without departing from the spirit and scope of this disclosure. For example, FIG. 9 shows conveyance 108 being configured to elevate and convey the soil via a continuous conveyor 902 such that soil can be continuously fed to the conveyance and subsequently to the entry point 116. As such, continuous conveyor 902 may include, or may be, a flat endless conveyor belt mounted on a roller assembly as known in the art of conveyor systems. For example, an upper conveyor belt contacting and carrying the soil may be translated upward while a lower conveyor belt (not in contact with the soil) is concurrently translated downward. The conveyor belt may be surrounded by lateral walls that keep the soil from spilling laterally off the conveyance 108.

The illustration of FIG. 5 presents a cross-sectional view of an exemplary implementation of augmentation system 112. As described above, augmentation system 112 may be configured to complement the gravitational assistance afforded by chute 110 to the speed and momentum of screened soil flowing therein. The illustration of FIG. 5 particularly shows an example implementation of augmentation system 112 in the form of an auger 502 arranged in a housing 504 and configured to emit screened soil through nozzle 114 and exit point 118. Auger 502 may include a plurality of helical blades axially spaced along a shaft, and may allow screened soil to flow proximate to the blade surfaces and between the blades and shaft. In this way, the resistance to screened soil flow can be minimized and thus soil flow maximized. Auger 502 may be comprised of any suitable material(s) such as various metal alloys, and may have blades whose angles and/or dimensions are specifically configured to move screened soil at appropriate rates given various rotational speeds of the auger and soil densities, in contrast, for example, to off-the-shelf or original equipment manufacturer (OEM) auger blades. Auger 502 may be operatively coupled to a suitable device to enable rotational blade motion, such as a motor.

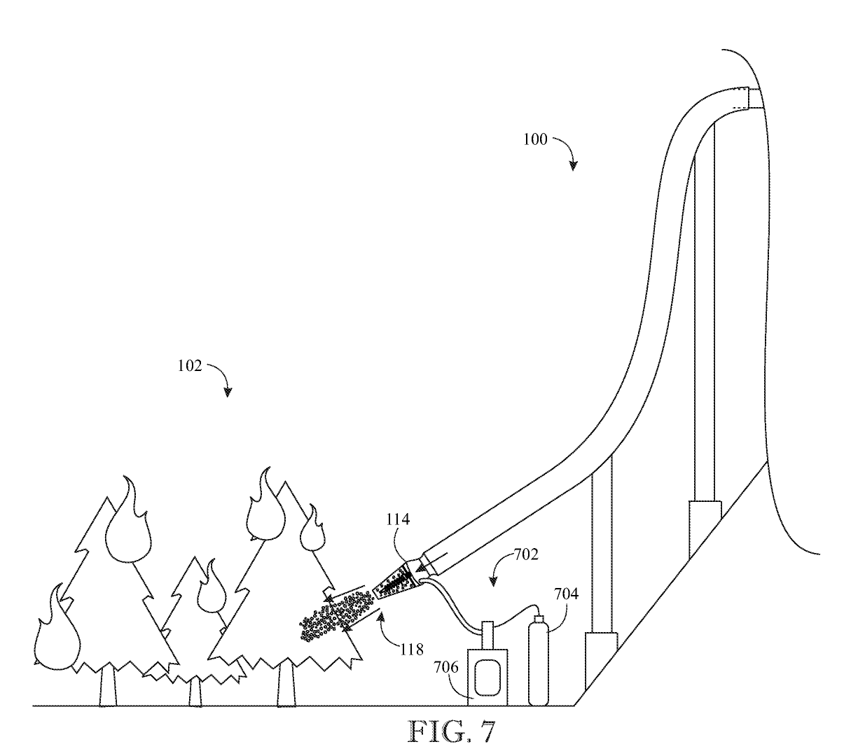

The illustration of FIG. 5 also presents the potential inclusion of a gas augmentation system in augmentation system 112, In particular, a partial view of a gas line 506 is shown by which a suitable pressurized gas may be supplied to the interior of housing 504 to increase the flow of screened soil through nozzle 114. The gas augmentation system may be used alternatively or in addition to auger 502 or other mechanical augmentation systems described below. Various suitable gas(es) may be supplied via gas line 506, including but not limited to carbon dioxide, nitrogen, and air, some of which may aid in fire suppression. Carbon dioxide, for example, may aid in fire suppression and may be produced from a variety of sources at relatively low cost. Regardless of the particular gas(es) employed, the gas(es) may increase screened soil flow by separating soil in housing 504. Additional details regarding the gas augmentation system are described below with reference to FIG. 7.

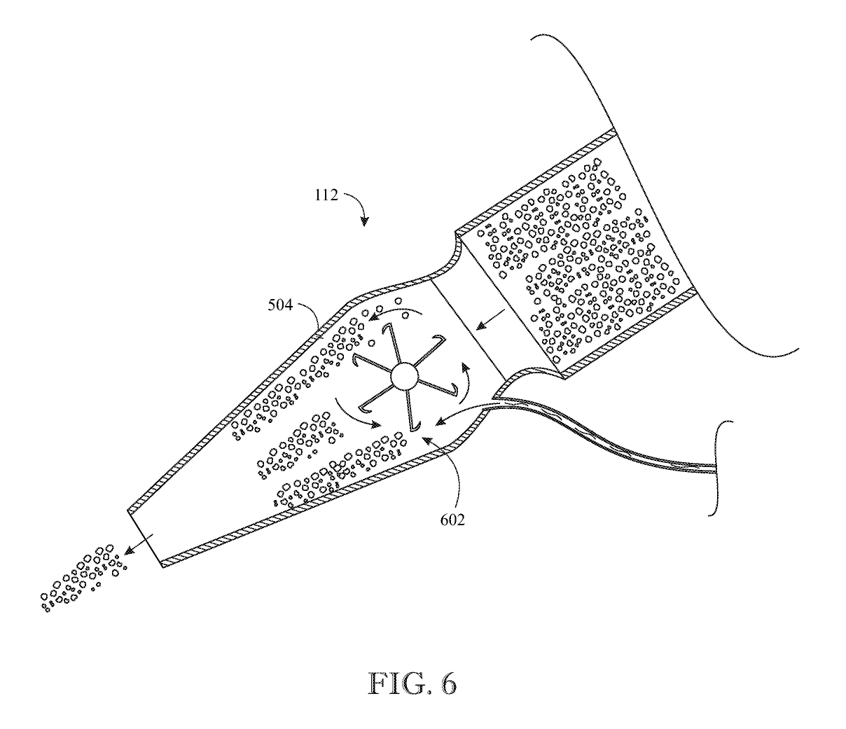

Other mechanical implementations of augmentation system 112 are contemplated. The illustration of FIG, 6 presents a cross-sectional view of another exemplary implementation of augmentation system 112 comprising a rotary projector 602. Rotary projector 602 may comprise a plurality of blades (e.g., five or six scoop blades) mounted on a (e.g., steel) wheel that rotate (e.g., counterclockwise) a (e.g., horizontal) plane substantially perpendicular to the axis of nozzle 114. The hooked distal ends of the blades may enhance contact with, and separation of, screened soil such that centrifugal force is imparted to the soil to enhance soil distribution and flow. Rotary projector 602 may be specifically configured and/or fortified to handle screened dirt, in contrast, for example, to similar off-the-shelf or original equipment manufacturer (OEM) projectors. A suitable device such as a motor may be operatively coupled to rotary projector 602 to drive the rotary projector. The illustration of FIG. 6 also presents the potential use of the gas augmentation system described above.

Alternative or additional mechanical implementations of augmentation system 112 are contemplated. For example, an impeller may be used alternatively or in addition to auger 502, and may be of relatively smaller length, of relatively more robust construction, and/or may be more suited to denser soils and materials. As another example, a blade assembly similar to those used for blowing snow but having relatively thicker blades and/or a relatively more severe blade angle may be used, particularly for moving heavier and/or denser soils. As yet another example, two or more impellers may be employed with either a single nozzle or two or more nozzles (e.g., a respective nozzle for each impeller). For implementations in which two or more impellers are employed, chute 110 may be endowed with a relatively greater diameter and/or with one or more blades positioned in the chute.

The illustration of FIG. 7 presents a partial view of exemplary firefighting system 100 emitting screened soil toward fire site 102 to thereby suppress fire therein. In particular, the emission of screened soil from nozzle 114 at exit point 118 is shown, a gas supply/control system 702 for selectively supplying gas to the gas augmentation system described above and to the interior of nozzle 114. Gas supply/control system 702 may include a gas reservoir 704, which may be a pressurized tank, and may include a pump and/or suitable valve mechanism (e.g., one way valve) for enabling the selective supply of gas therein to the interior of nozzle 114. Gas reservoir 704 may feed released gas to a control system 706, which may include various sensors and/or actuators for facilitating selective gas application. For example, control system 706 may include a pressure sensor and/or mass flow sensor for respectively measuring the pressure and/or mass flow of gas released from reservoir 704. In some examples, control system 706 may control the release of gas from reservoir 704, for example by actuating the valve mechanism of the reservoir and/or by actuating its own valve mechanism. In some examples, control system 706 may include an input device to enable human operation of the control system and selective release of gas from reservoir 704. Alternatively or additionally, control system 706 may include a communications subsystem for interfacing (e.g., via wired or wireless connection) with a remote computing or input device and receiving from the device commands controlling gas supply. As such, control system 706 may include a computing subsystem to handle control, input, and/or communication.

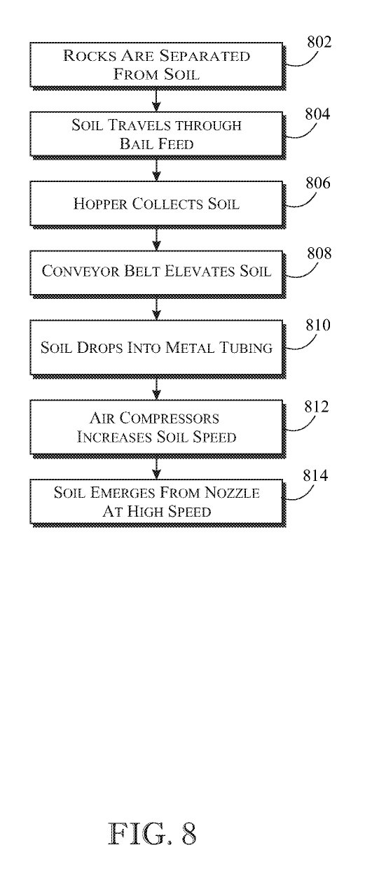

The illustration of FIG. 8 presents an exemplary method 800 of fire suppression. Method 800 may be employed using firefighting system 100 of the illustration of FIG. 1, for example.

At 802, method 800 includes separating rocks from soil. The soil may be collected at a fire site or proximate the fire site. Rocks and/or other debris may be separated from the soil via process 200 presented in the illustration of FIG. 2, for example, and separation may include isolating particles of a desired size range. As such, screened soil may be obtained.

At 804, method 800 includes routing the screened soil through a bail feed. Slide 302 of the illustration of FIG. 3 may be used to route the screened soil, for example.

At 806, method 800 includes collecting the screened soil at a hopper. The hopper may be reservoir 106 of the illustration of FIG. 1, for example.

At 808, method 800 includes carrying the screened soil to high elevations via a conveyor belt. The conveyor belt may be conveyance 108 of the illustration of FIG. 1, for example.

At 810, method 800 includes dropping the screened soil into a metal tubing. For example, the screened soil may be supplied to chute 110 at entry point 116, both of the illustration of FIG. 1.

At 812, method 800 includes air-compressing the screened soil to increase soil speed. Air or any other suitable gas(es) may be used, which may be supplied via the gas augmentation system presented in the illustration of FIG. 7, for example, to increase the soil speed.

At 814, method 800 includes emitting the screened soil through a nozzle at relatively high speeds. The screened soil may be emitted from nozzle 114 at exit point 118, both shown in the illustration of FIG. 1, for example.

In view of the above, firefighting system 100 may provide a collapsible, dynamically deployable approach to suppressing and/or extinguishing fires by utilizing naturally abundant resources available at or proximate to a fire site. In this way, the cost, complexity, and risks associated with other firefighting approaches may be reduced.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A firefighting system, comprising:
a conveyance configured to receive and elevate screened soil;
a chute configured to receive the screened soil at an entry point; and
a nozzle configured to emit the screened soil toward a fire site, the nozzle comprising an augmentation device configured to increase a flow speed of the screened soil.

2. The firefighting system of claim 1, wherein the augmentation device comprises an auger.

3. The firefighting system of claim 1, wherein the augmentation device comprises a rotary projector.

4. The firefighting system of claim 1, wherein the augmentation device comprises a gas augmentation system that selectively introduces a pressurized gas into the nozzle.

5. The firefighting system of claim 4, wherein the gas augmentation system comprises a tank holding the pressurized gas.

6. The firefighting system of claim 4, wherein the gas augmentation system further comprises a control system configured to selectively control the introduction of the pressurized gas into the nozzle.

7. The firefighting system of claim 1, wherein the firefighting system is at least partially collapsible.

8. The firefighting system of claim 1, wherein the chute is configured to increase a speed of the screened soil by reducing an elevation of the screened soil via gravity.

9. The firefighting system of claim 1, wherein the nozzle is configured to emit the screened soil at an exit point that is lower than the entry point.

10. The firefighting system of claim 9, wherein a differential height between the entry point and the exit point is between 20 and 50 ft.

11. The firefighting system of claim 1, wherein the conveyance comprises a conveyer belt.

12. The firefighting system of claim 1, wherein a distance between the nozzle and the fire site is between 50 and 150 ft.

13. A firefighting system, comprising:
a conveyance configured to receive and elevate screened soil;
a chute configured to receive the screened soil at an entry point; and
a nozzle configured to emit the screened soil toward a fire site through an exit point, the nozzle comprising a mechanical augmentation device configured to increase a flow speed of the screened soil.

14. The firefighting system of claim 1, wherein the mechanical augmentation device comprises an auger.

15. The firefighting system of claim 1, wherein the mechanical augmentation device comprises a rotary projector.

16. The firefighting system of claim 1, wherein the mechanical augmentation device comprises an impeller.

17. The firefighting system of claim 1, wherein the mechanical augmentation device comprises a blade assembly.

18. The firefighting system of claim 1, further comprising a gas augmentation system configured to increase the flow speed of the screened soil.

19. The firefighting system of claim 1, wherein the chute is configured to increase the flow speed of the screened soil via gravity.

20. A firefighting system, comprising:
a conveyor belt configured to receive and elevate screened soil;
a chute elevated via a plurality of supports and configured to receive the screened soil at an entry point;
a nozzle configured to emit the screened soil toward a fire site, the nozzle comprising an augmentation device configured to increase a flow speed of the screened soil; and
a gas augmentation system configured to selectively introduce a pressurized gas into the nozzle to increase the flow speed of the screened soil.
